(19) United States
(12) Patent Application Publication
(10) Pub. No.: US 2017/0235915 A1
(43) Pub. Date: Aug. 17, 2017

(54) PERSONALIZED MODEL WITH REGULAR INTEGRATION OF DATA

(71) Applicant: Siemens Healthcare GmbH, Erlangen (DE)

(72) Inventors: Tommaso Mansi, Plainsboro, NJ (US); John Paulus, JR., East Windsor, NJ (US); Tiziano Passerini, Plainsboro, NJ (US)

(21) Appl. No.: 15/417,941

(22) Filed: Jan. 27, 2017

Related U.S. Application Data
(60) Provisional application No. 62/296,167, filed on Feb. 17, 2016.

(51) Int. Cl. G06F 19/00

(52) U.S. Cl. CPC G06F 19/3437; G06F 19/322; G06F 19/3418

(57) ABSTRACT

For personalized modeling with regular integration from a sensor, a wearable sensor and/or sensor outside of the medical facility or environment provides health-related data on a regular, periodic, or continuous basis (e.g., every few minutes or hours). Rather than using that data alone, the data is used to update a previously created personalized model of anatomy of the patient. After updating a parameter value for the personalized model, the updated model is used to output more complex health-related information than provided by the sensors.

### RELATED APPLICATIONS

The present patent document claims the benefit of the filing date under 35 U.S.C. §119(e) of Provisional U.S. Patent Application Ser. No. 62/296,167, filed Feb. 17, 2016, which is hereby incorporated by reference.

### BACKGROUND

The present embodiments relate to personalized modeling of anatomy and physiology. By personalizing a model to a particular patient, physicians may use the model for diagnosis, prognosis, treatment planning, or to detect an adverse event for the patient. Due to the effort and cost, the creation and use of a model is typically limited to during a hospitalization or after occurrence of an adverse event.

Proactive monitoring of health is still at its early stages, with very few solutions available. Most solutions are mono-modality, such as a heart rate sensor or activity (step) sensor. These solutions are typically coordinated and managed by the patient without physician input and are overly simplistic.

Many sensors are used in a medical environment. With the multiplication of medical sensors (e.g., imaging scanners, biosensors, diagnostics, and/or wearable devices), the integration of medical data is becoming challenging. There is a growing need for innovative solutions to collect, centralize and organically analyze the large amount of per-patient information available. This abundance of information may be incompletely organized and poorly translated into valuable information for the patient as well as for the patient's care providers.

### SUMMARY

By way of introduction, the preferred embodiments described below include methods, computer readable media, and systems for personalized modeling with regular integration from a sensor. A wearable sensor and/or sensor outside of the medical facility or environment provides health-related data on a regular, periodic, or continuous basis (e.g., every few minutes or hours). Rather than using that data alone, the data is used to update a previously created, personalized model of anatomy and physiology of the patient. After updating a parameter value for the personalized model, the updated model is used to output more complex health-related information than provided by the sensors.

In a first aspect, a method is provided for personalized modeling with regular integration from a sensor system. Spatial data of an organ of a patient is captured with a medical scanner. A model of dynamic behavior of the organ is created. The model is personalized to the patient with the spatial data. Periodic readings are captured from a wearable sensor worn by the patient. In response to the periodic readings, the model is periodically updating with a most recent reading. The dynamic behavior of the organ is periodically modeled with the model as updated. A risk of an adverse event for the organ is output based on at least one iteration of the periodic modeling.

In a second aspect, a system is provided for personalized modeling with regular integration of data. A sensor is for on-going sensing of a patient. A memory is configured to store values from the on-going sensing and a physics model of the patient. A processor is configured to regularly fit the physics model to the patient based on the values received from the sensor since a previous update, to determine a state of the patient from the updated model, and to generate an output for the patient based on the state.

In a third aspect, a method is provided for personalized modeling with regular integration from a sensor system. Signals from a patient are sensed outside a medical facility with an e-health sensor. A parameter personalizing of a mechanistic model of organ function of the patient is modified based on signals from the sensing. The organ function is modeled with the mechanistic model as modified. The sensing, modifying, and modeling are repeated in real-time. Health data for the patient from at least one iteration of the modeling is transmitted.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for personalized modeling with regular integration of data;

FIG. 2 illustrates an example infrastructure of the system of FIG. 1;

FIG. 3 illustrates another example infrastructure of the system of FIG. 1;

FIG. 4 is a flow chart diagram of one embodiment of a method for personalized modeling with regular integration from a sensor system; and

FIG. 5 illustrates an example heart model.

### DETAILED DESCRIPTION OF THE DRAWINGS AND PRESENTLY PREFERRED EMBODIMENTS

A virtual avatar includes continuous integration of imaging, clinical, and sensor data. There is an enormous potential in managing the flow of information from all available sensors. Data from one or more sensors is integrated with diagnostic imaging to create a mechanistic model. The mechanistic model of organ function, estimated from diagnostic imaging and sensors, is updated to continuously integrate data from e-health sensors. Imaging data from follow-up exams may also be used to update the mechanistic model. Risk factors of adverse events or other health data may be determined from the updated model. By using integrating from sensors available outside and/or inside of the medical facility, real-time monitoring using the modeling may be provided.

Continuous, active monitoring using sensor measurement may allow the early detection of disease markers to guide optimal patient care. The risk of adverse events, including stroke and sudden cardiac death, may be monitored and better predicted based on the integration of sensor data into modeling, potentially resulting in early treatment of such events to prevent negative outcomes. The updated model may be used to continuously update therapeutic devices, like cardiac resynchronization therapy devices (advanced pace makers), based on a patient's health indicator as output by the model.

In the example embodiments below, a cardiac use case is provided. The heart and/or circulatory system of the patient is modeled. In other embodiments, applications for modeling other anatomy and/or function may be provided, such as modeling liver, gastro-intestinal, brain, lung, or other anatomy function. The whole body of a patient may be modeled. Any organ, anatomy, or physiological system may be modeled. Any of these models may be updated or modified based on data from a wearable sensor or other health sensor used outside of a medical facility or in an ongoing manner.

FIG. 1 shows one embodiment of a system for personalized modeling with regular integration of data. The system includes devices (e.g., sensors 13 for model creation and the medical imaging system 11) used to originally create the model and devices (e.g., wearable sensor 15) for updating the model on an on-going basis. In other embodiments, only the devices for updating are provided. While one processor 12 and memory 14 is provided for both the creation and updating, separate processors 12 and/or memories 14 may be used for creation and updating.

The system includes a medical imaging system 11, a processor 12, sensors 13, a memory 14, a wearable sensor 15, and a display 16. The processor 12 and the memory 14 are shown separate from the medical imaging system 11, such associated with being a computer, workstation, or server apart from the medical imaging system 11. In other embodiments, the processor 12 and/or memory 14 are part of the medical imaging system 11. In alternative embodiments, the system is a workstation, computer, or server for updating a model and modeling or computing with the updated model.

Additional, different, or fewer components may be used. For example, other sensors are used to gather patient-specific data for creation and/or for updating. As another example, the sensors 13 for creation of the model are not provided. In yet another example, one or more computer networks and corresponding interfaces for communication are provided.

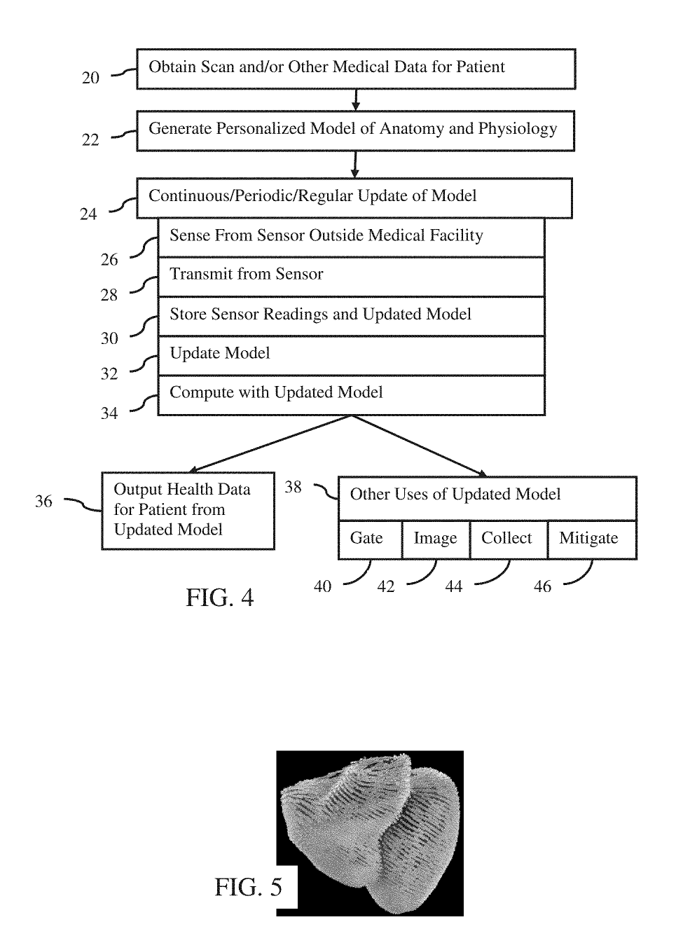

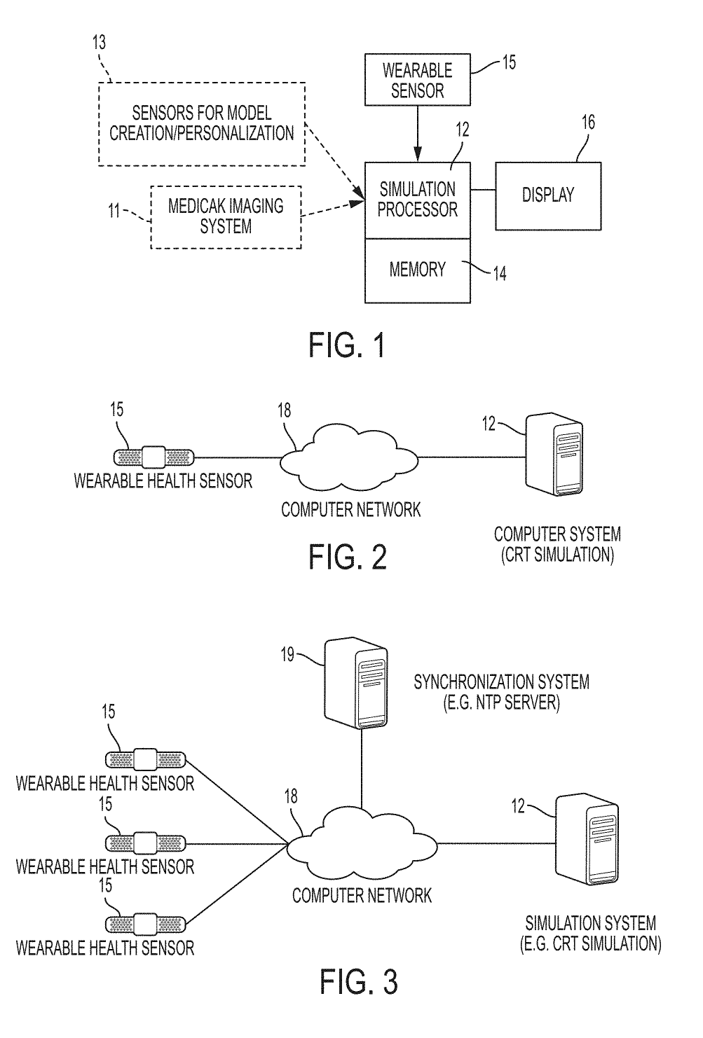

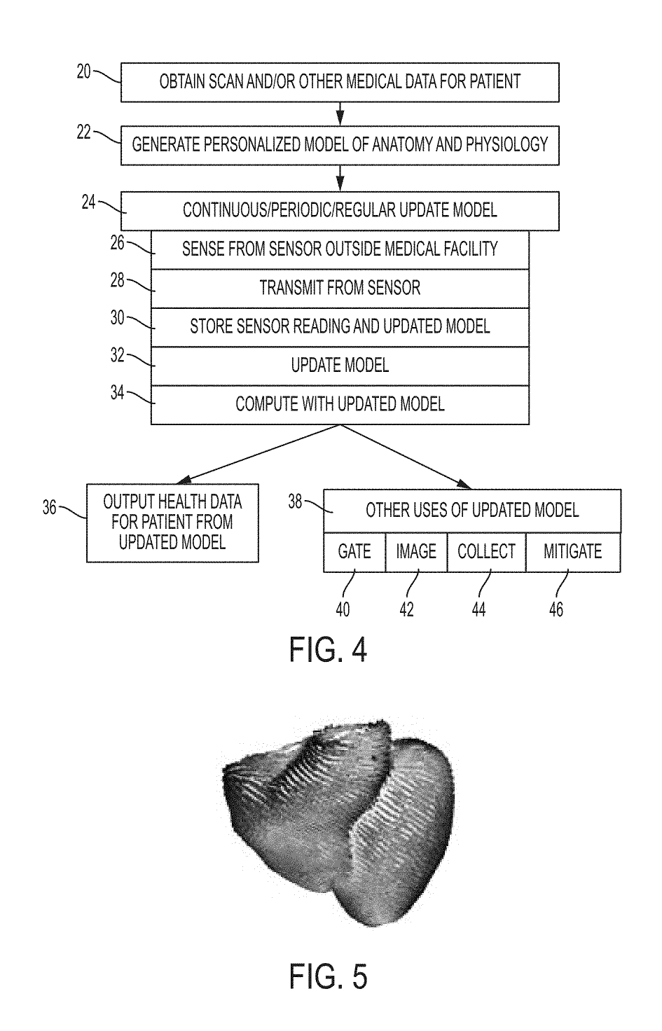

The computing components, devices, or machines of the system, such as the medical imaging system 11 and/or the processor 12 are configured by hardware, software, firmware, and/or design to perform calculations or other acts. The computing components operate independently or in conjunction with each other to perform any given act, such as the acts of FIG. 4. The acts are performed by one of the computer components, another of the computing components, or a combination of the computing components. Other components may be used or controlled by the computing components to scan, sense, or perform other functions.

The medical imaging system 11 is any now known or later developed modality for scanning a patient. The medical imaging system 11 scans the patient for an anatomical region. For example, a C-arm x-ray system (e.g., DynaCT from Siemens), CT like system, or CT system is used. Other modalities include MR, x-ray, angiography, fluoroscopy, PET, SPECT, or ultrasound. The medical imaging system 11 is configured to acquire the medical imaging data representing part or all the heart. Data representing one or more vessels may be acquired. The data is acquired by scanning the patient using transmission by the scanner and/or by receiving signals from the patient. The type or mode of scanning may result in receiving data of just part of the cardiovascular system. Alternatively, data of a volume region is received and the vessel and/or heart information is segmented from information of other anatomy.

The sensor 13 for personalization of the model is a pressure cuff, EKG sensor, other sensor, or combinations thereof. A pressure cuff is adapted for sensing pressure on an arm of the patient, but may sense pressure at other locations. In alternative embodiments, other pressure sensors may be used, such as a pressure sensor on a catheter inserted within the patient. The EKG sensor is a plurality of electrodes connected with a circuit or processor. An EKG waveform, heart rate, and/or phase designators sensed from the electrical signals are output by the EKG sensor.

The sensors 13 and medical imaging system 11 provide information for originally creating a personalized model of anatomy and function (e.g., model of the heart or cardiac system). The wearable sensor 15, other sensors, or fewer devices may be used to originally create the model. Data is sensed from the patient and used to fit the mechanistic model to the patient. This updates the model to the current state of the patient. Any level of personalization may be used, such as altering just one parameter or many parameters based on data from the patient.

The wearable sensor 15 is a heart rate sensor, temperature sensor, EKG sensor, pulse-oximetry sensor, breathing sensor, glucose sensor, step or activity sensor, other sensor, or combinations thereof. Electrodes, accelerometers, gyroscopes, infra-red sensor, or other sensing devices may be used. One sensor integrating multiple sensing functions or separate sensors may be used. Any characteristic of the patient or function of the patient may be sensed for on-going updating of the model.

The wearable sensor 15 rests against, is strapped to, is connected to, or otherwise positioned to sense the patient. A sensor, battery, wire, memory, processor, wireless transceiver or transmitter, electrodes, antenna, housing and/or another sensor element are sized and shaped to be carried by the patient. For example, the wearable sensor is part of a watch or strap around a wrist or arm of the patient. In other examples, straps for an ankle, neck, or other appendage are provided. In yet other examples, various sensing elements connect at different locations on the patient and a processor or electronics are provided in or on a pocket, belt, necklace, clothing, watch, or other component carried by the patient. The wearable sensor 15 has less volume than a phone, but may be larger (e.g., fanny pack or back-pack sized or carried). The wearable sensor 15 communicates with a computer network (e.g., Wi-Fi access point) or other devices (e.g., communicating to a cellular phone also carried by or in the proximity of the patent).

The wearable sensor 15 is configured by hardware, software, and/or firmware to regularly sense the patient. Any period may be used for on-going sensing, such as periodically sensing every number of seconds, minutes, or hours. Daily or weekly sensing may be used in other embodiments. For real-time or continuous sensing, the sensing is every minute or more frequent. The wearable sensor 15 provides more recent information about the patient than information acquired at a medical facility and/or than the information used to create the model. This on-going or at least one update of information may be used to refine the previously personalized model so that the model more likely reflects a current health state or operation of the modeled anatomy and function.

The memory 14 is a buffer, cache, RAM, removable media, hard drive, magnetic, optical, database, or other now known or later developed memory. The memory 14 is a single device or group of two or more devices. The memory 14 is within the medical imaging system 11, part of a computer with the processor 12, within a cellular phone (e.g., smart phone), part of the wearable sensor 15, or is outside or remote from other components. The memory 14 is configured (e.g., formatted or indexed for data storage) by the processor 12 or another device.

The memory 14 is configured to store values from the on-going sensing and a physics (e.g., mechanistic) model of the patient. The values from the wearable sensor 15 are received and stored for use in updating the model. A computer network interface, wireless receiver, or other device may be used to receive the signals from the wearable sensor 15 for storing the signals. Alternatively, the memory 14 is part of the wearable sensor 15, so stores the values as the values are acquired.

The model is stored in the memory 14 with the values from the on-going sensing. Values of parameters for personalizing or fitting a generic model to a patient are stored. Other model information, such as the imaging or spatial data used to create the model, may be stored. In alternative embodiments, the model is stored in a separate memory device from the values.

In one embodiment for real-time or continuous integration of the signals from the sensor, the memory 14 is configured as a circular lock-free buffer with at least two slots. One slot (i.e., buffer region) is for storing the received values from the wearable sensor 15, and the other slot is for updating the model. The heart model is updated live by the processor 12 using multi-threading technology. First, a “listener” component is used to listen to a network socket for incoming sensor data to be stored in one slot of the memory 14. The received data is integrated into the model by modifying the respective parameters (e.g. heart rate, QRS duration, glucose, or others). A computation is triggered in the background, in another thread, to calculate a new state of the organ model. For the memory 14, the non-lock approach is used to support this multi-thread process. The circular buffer with two slots is employed to store the organ model. Two heads are used, one for read, and one for write. Model queries are done using the read head. When re-computation (e.g., update) is triggered, the model is updated and written using the write head. Read and write heads are then shifted accordingly and the model updated. The slots switch. The slot that was storing incoming data switches to being the slot supporting the model, and the other slot that supported the model switches to be the slot storing the incoming values. The slots cycle between storing the values and the model while the processor 12 fits the physics model and determines the state.

The memory 14 is additionally or alternatively a non-transitory computer readable storage medium with processing instructions. The memory 14 stores data representing instructions executable by the programmed processor 12. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The simulation processor 12 is a general processor, digital signal processor, three-dimensional data processor, graphics processing unit, application specific integrated circuit, field programmable gate array, digital circuit, analog circuit, combinations thereof, or other now known or later developed device for modeling from medical data. The simulation processor 12 is a single device, a plurality of devices, or a network. For more than one device, parallel or sequential division of processing may be used. Different devices making up the simulation processor 12 may perform different functions, such as personalizing by one device and computation of a metric by another device. In one embodiment, the simulation processor 12 is a control processor or other processor of the medical imaging system 11. The processor 12 operates pursuant to stored instructions to perform various acts described herein.

The simulation processor 12 is configured to personalize a model of anatomy and function. One or more parameters of a closed-loop cardiovascular or other physics model are personalized. The values making the model better represent a specific (state of a) patient are calculated from measurements or other information for that patient.

Using the on-going integration of sensor data from the wearable sensor 15, the simulation processor 12 regularly fits the personalized physics model to the patient based on the values received from the sensor 15 since a previous update. If the sensors indicate a change (e.g., different pressure or heart rate), one or more values of the parameters of the model are modified so that the personalized model represents the current state, as indicated by the signals from the sensor 15, of the anatomy and function of the patient.

The modification uses any solution, such as an optimization with or without limitations on which parameters may be modified. The model is iteratively adjusted until the model provides values that match the signals from the sensor. In one embodiment, the simulation processor 12 is configured to apply a machine-trained classifier. The model may be created by machine-learning, so the new signals are treated as additional training data for updating the training. The update in the training with the additional training data modifies the model to account for the current information from the patient. In other embodiments, the sensor data is used to determine a change in a value of a parameter by a direct mapping or function.

The processor 12 is configured to determine a state of the patient from the updated model. The model is used to derive health data for the patient. The processor 12 generates an output for the patient based on the state of the organ as represented by the model. The personalized model is used to determine a value for a metric of interest, such as any health data (e.g., prognosis, diagnosis, risk of adverse event, pacing information, physiological cycle information, treatment prediction, or reaction).

The display 16 is a CRT, LCD, plasma, projector, printer, or other output device for showing an image. The display 16 displays the quantity or quantities calculated using the personalized model. The quantities may be displayed in a chart, graph, and/or on an image, such as a rendering of the model. The display 16 may be part of a wearable device.

The processor 12 and memory 14 may be part of a separate computer, the medical imaging system 11, a server, or the wearable sensor 15. For example, the virtual organ simulation and/or data integration is run continuously directly on the wearable sensor 15. A separate client/server or computer is not needed. As another example, the processor 12 and memory 14 are provided as part of a cloud, such as providing on one or more servers.

In other embodiments, a server is used to perform the modeling and/or updating. FIG. 2 shows one embodiment. A wireless transmitter or transceiver of the wearable sensor 15 transmits patient-specific sensed data to a remote computer system that is running a cardiac simulation with the simulation processor 12. In the example of FIG. 2, the transmission uses a computer network 18 to communicate the signals from an access point (e.g., Wi-Fi access point) to the simulation processor 12 of the computer or server. Any wireless technologies may be used to transmit the patient specific health data, including Bluetooth and Wi-Fi.

In one embodiment, an APPLE, FITBIT, or other watch with an e-health sensor collects the patient's heart rate data. The patient's heart rate data is then transmitted using wireless technology to an Apple iPhone or other cellular device. The patient's heart rate data is stored in a system level service in the iPhone called ‘HealthKit’ or stored in a memory of the cellular phone. The data is retrieved from HealthKit or memory by an application, and then the data is transmitted from the phone to the remote computer for the simulation processor 12. This architecture provides real-time simulations with the user's health data/vital signs as input. For this implementation, the phone ‘middleman’ marshals the data from the wearable sensor 15 to provide the data to the remote computer or server. Other implementations of this infrastructure do not require this extra network step. Other architectures for communicating the sensor data for updating the model and/or for communicating model output to the patient, physician or electronic medical record for the patient may be used.

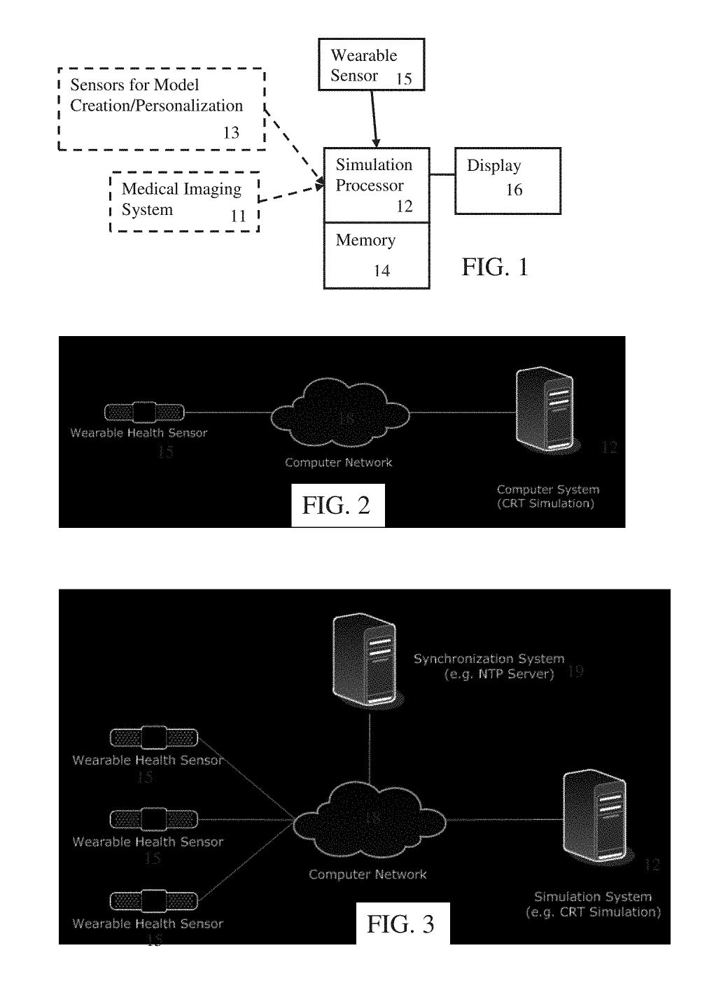

FIG. 3 shows another embodiment of the system of FIG. 1. For some medical diagnoses or modeling, the patient wears multiple health sensors 15 simultaneously or has a sensor 15 that includes more than one type of sensing. Multiple inputs from the different sensors 15 are transmitted, such as via the computer network 18, in real-time. The transmissions are simultaneous, in parallel and/or are sequential.

The signals from the sensors 15 represent the state of the patient at a given time. Where the sensors 15 share a same clock, the signals from the different sensors 15 are time stamped and/or have a same time reference. Where the different sensors 15 have independent clocks, the temporal relationship of the signals are based on synchronization. Synchronization is achieved by timestamping each sample, and the sensors 15 generating samples are themselves synchronized to a single governing clock, such as being registered with a network time protocol (NTP) server 19. Other synchronization may be used, such as relying on transmitted beat signals or time information received by the sensors 15.

FIG. 4 shows a flow chart for one embodiment of a method for personalized modeling with regular integration from a sensor system. On-going sensor data from one or more wearable sensors or sensors for the patient used outside of a medical facility are integrated with modeling of anatomy and function. The integration modifies the previously personalized model to better reflect a current state of the anatomy of the patient. The modified model may then be used to output health information more than the sensed data, such as health information providing values for metrics not directly determined from the sensed signals.

The method is implemented by a medical diagnostic imaging system, a review station, a workstation, a computer, a picture and archiving and communications system (PACS) station, a server, a mobile phone, a sensor, combinations thereof, or other device for creating a model, collecting sensor signals, updating the model based on the signals, and/or outputting health data from the model. For example, the medical image system, computer of a healthcare facility, or server creates a model from scan data acquired by scanning the patient and/or from signals from sensors for monitoring the patient in the healthcare facility. The same or different processor, such as a server different than any server or processor used to create, receives on-going sensor signals, updates the model, and/or outputs using the updated model. A wearable sensor or sensor outside the healthcare facility (e.g., sensor at a home or office of the patient) provides signals representing the patient after creation of the personalized model for that patient. These signals are provided to the simulation processor for updating the model. In one embodiment, the system of FIG. 1, 2, or 3 is used, but other systems may be used.

The method is implemented in the order shown or a different order. For example, act 38 is performed before, after, or simultaneously with act 36.

Additional, different, or fewer acts may be performed. For example, act 28 is not performed where the modeling and updating of the model are performed on the sensor. As another example, acts 20 and 22 are not performed where an already personalized model is available. In another example, any one or more of acts 36-46 are not provided and/or other output acts are performed. In yet another example, acts for storing scanned data and/or transfer of results are provided.

Acts 20 and 22 may be performed as the patient is scanned or later. Act 24 and the associated acts 26-34 are performed in real-time, such as in an on-going manner while the state of the patient is sensed. In other embodiments, the storage of the sensor readings in act 30 allows delay of acts 32 and 34. By performing act 24 periodically, regularly, or continuously with the acquisition of data from the sensor, a real-time implementation of the modeling as updated to account for the current state of the patient may be provided.

For initial creation, the physician causes the patient to be scanned or obtains scan data for the patient from a previous scan. The physician may activate the process and input patient-specific information, such as a metric of interest, age, sex, and/or weight. Once personalization and/or metric computation are activated, the method is performed without any user input, such as without user input of locations and/or values. The sensing and integration of sensed signals to update the model as well as the modeling are performed automatically. Alternatively, the user assists in a semi-automated process, such as the user indicating possible values of properties, activating the sensing of signals, activating transmission of signals, and/or activating updating of the model. Other user input may be provided, such as for changing modeling parameter values, correcting output, and/or to confirm accuracy.

Acts 20 and 22 provide for creation of an initial model. This creation may be triggered by an adverse event, such as a health problem resulting in medical examination at a healthcare facility. The gathering of data for the personalization is performed at the healthcare facility, but may rely on data obtained from other sources outside the healthcare facility and/or from other times (e.g., after or prior to the adverse event).

Any approach for creating a model of anatomy or function for a patient may be used. Any personalization of that model to the specific patient may be used. The model may initially be a template that is fit to the data representing the patient. The model may instead be non-existent, but learned from the data for the patient using machine-learning. In one embodiment, the model is derived from a population of patients, resulting in a standard or typical model for a class of patients. This standard model is then personalized to a specific patient. Data representing the specific patient is used to personalize.

In act 20, spatial data of an organ of a patient is captured with a medical scanner. For example, an ultrasound scanner captures ultrasound data of a heart of the patient where the model is of the heart. One or more of different types of data are obtained. For example, data from a computerized medical record is obtained, such as diagnosis, age, weight, and sex. In one embodiment, scan, electrophysiology function, and biomechanics data are obtained. The electrophysiology function data is ECG measurements measured with electrodes and an ECG sensor, but other function data may be obtained. The biomechanics data is pressures measured with a pressure cuff, but internal pressures may instead or additionally be measured with a pressure sensor on a catheter. Biomechanics data may also include blood flow rate measurements obtained either invasively (with catheters) or non-invasively (e.g. using Echo Doppler or PC MRI). The scan data is image data or spatial data measured with a medical diagnostic scanner, such as an ultrasound, computed tomography, x-ray, fluoroscopy, angiography, or magnetic resonance scanner. Any scanning sequence or approach may be used. Other types of data may be obtained as well or instead.

The data is obtained at a same time, such as measuring pressure and function while also scanning. Alternatively, the data is obtained at different times, such as in sequence during a single patient visit or appointment or in sequence across hours or days.

The data is acquired by scanning and/or measuring the patient. In an alternative embodiment, the data is acquired by loading from memory. Data from a previously performed scan of the patient is stored in a memory, such as a picture archiving and communications system (PACS) database. The data is selected from the database. The data may be obtained by transfer, such as over a network or on a portable memory device.

The scan data represents a volume, but may be a 2D image or represent an area for imaging a plane or slice. The scan data is organized or formatted as a frame, set of data, sets of data, or other collection to represent the volume. The scan data represents locations distributed in three dimensions. The volume includes the heart and one or more vessels. Only a portion of the heart may be imaged in other embodiments. Scan data of the volume over time may be acquired.

In act 22, the processor generates a model of the organ. The model is a static representation of the organ. In other embodiments, the model is of dynamic behavior of the organ, such as being a static model where physics is used to show change over time or being a model that includes temporal change. Any mechanistic, physics, or other modeling may be used. In one embodiment, the model of the dynamic behavior incorporates multiple different models, such as an anatomical model, electrophysiology model, hemodynamic model, and electro-mechanical model (e.g., generating an electro-mechanical model based on hemodynamics and electrophysiology). Any model may be used.

The model is personalized to the patient with the spatial and/or other data representing the patient. The model includes one or more parameters. The data representing the patient may be used to determine values for the one or more parameters. A look-up table or calculation using a relationship function may map the data to values. In other approaches, the model is altered iteratively using any optimization so that the model provides for values matching the data representing the patient. Other personalization using the data representing the patient to determine values for one or more parameters of the model may be used.

In one embodiment, a patient-specific computational model of the heart function is derived from imaging and clinical data. Starting from 3D images of the heart (e.g. MRI, CT or ultrasound), the boundaries of the myocardium are segmented. The contours of the left ventricle endocardium, right ventricle endocardium, and left ventricle epicardium are segmented using machine learning techniques or other image processing. The model may instead be or include the atria or the whole heart. The contours are then fused to form a volumetric three-dimensional (3D) mesh representing the heart or part of the heart.

Myocardium fibers are mapped to the model. The fibers are derived either from a generative, rule-based model or from diffusion tensor imaging (DTI). The result is a detailed anatomical model of the heart. FIG. 5 shows an image rendered from one view of an anatomical model. The generally parallel lines over the two viewable heart chambers represent myocardium fibers. Other models of the anatomy of the heart based on the same or different personalization may be used.

The model also includes a computationally efficient model of cardiac electrophysiology. From the 3D mesh, cardiac potentials are calculated over time. In one embodiment, a lattice Boltzmann method (LBM-EP) is used as an efficient model of cardiac electrophysiology. LBM-EP relies on the lattice-Boltzmann method to solve an anisotropic mono-domain equation of cardiac EP. In another embodiment, a graph-EP model is used instead of LBM-EP. Any cellular model may be employed. In one embodiment, the Mitchell-Schaeffer model is used. Tissue anisotropy is considered, in which electrical activation is faster along the myocardium fibers than across.

The model may also include a model of cardiac hemodynamics. For example, a lumped parameter model (e.g., one pressure value is calculated for the entire cardiac chamber) is used to control the cardiac phases according to arterial pressures (calculated using a 3-element Windkessel model) and atrial pressures (calculated using a lumped model of atrial contraction). In another embodiment, a full 3D computational fluid dynamics solver is employed with fluid-structure interactions.

The models are combined into a computationally efficient model of cardiac electro-mechanics. A biomechanical model of the heart is employed to calculate the pumping function resulting from the electrical activation and the hemodynamics load calculated with the cardiac electrophysiology and hemodynamic models. Two components are used: a passive component to capture the orthotropic nature of myocardium tissue (myocardium fibers and fiber sheets) and an active component that calculates the stress created by a myocyte during contraction. Other models may be used.

Each component is controlled by a set of parameters. The values of the parameters are singular for the model, vary with time, and/or vary spatially. The values for the parameters are estimated from the data representing the patient. The estimation may be based on inverse modeling or machine-learning. Other estimation, such as direct mapping or look-up from empirical data, may be used. At the end of the process, a virtual representation of patient's heart is obtained. This virtual avatar or model may be used to test different therapy outcomes, test current function, diagnosis, prognosis, or predict risk.

Another embodiment for modeling the circulatory system is taught in US Published Patent Application No. 2016-0196384, the disclosure of which is incorporated herein by reference. Personalized computation of the whole-body circulation is performed using medical images and signals for a patient. A comprehensive patient-specific multiscale computational model of the cardiovascular system is composed of a full-scale or reduced-order cardiac electro-mechanics model coupled to a whole-body circulation model. The multi-scale computational model is used to estimate parameters and calculate dynamics of the heart and the entire cardiovascular system. The parameters to be personalized may be specified a priori or may be identified automatically based on a set of metrics of interest. Once these parameters are known, their personalization is performed automatically.

In yet another embodiment, cardiovascular images, signals and data, including at least one medical image of a patient, acquisition of ECG, and systolic and diastolic cuff pressures, are acquired. To build the geometry of the heart or at least of one chamber (e.g., left ventricle) in at least two time phases of the cardiac cycle (e.g., peak systole and peak diastole), the images are segmented. Hemodynamic parameters, including time-varying parameterized flow rate functions and pressure variation functions for one or both heart chambers, and cardiovascular systemic and pulmonary impedances are personalized. Multiscale whole-body circulation model dynamics are computed with the personalized parameters. The computed data is visualized as outcome curves, or as scalar and/or vector fields overlaid or displayed as attributes of the segmented geometries or the imaging data.

A comprehensive closed-loop cardiovascular system (CLCS) model can simulate physiological and pathophysiological characteristics, and quantify the cardiac workload from those characteristics. This approach enables an understanding of the complex relationship between heart disease and the extra workload on the heart due to various pathologies such as hypertrophy, cardiomyopathy (arrhythmogenic right ventricular cardiomyopathy, isolated ventricular non-compaction, mitochondrial myopathy, dilated cardiomyopathy, restrictive cardiomyopathy, peripartum cardiomyopathy, takotsubo cardiomyopathy, loeffler endocarditis, etc.), mitral regurgitation, aortic stenosis, aortic regurgitation, and hypertension.

The multiscale cardiac models coupled to circulation models are personalized. Any one or more parameters in a given type may be personalized. One or more types of models may not be personalized, such as using a generic lumped model with personalization of one or more parameters of the 3D model. Sensitivity may be analyzed to determine which parameters to personalize for a given patient. To compute patient-specific hemodynamics, the circulatory and regulatory models are personalized. The overall function of the heart model portion is derived from imaging and clinical data of a patient for personalization. Any heart model may be used.

To couple the heart portion with the circulation portion, the values of any of the solution variables (e.g. pressure, flow rate, velocities, or others) are exchanged at each time step. The coupling may be performed implicitly or explicitly. For example, the coupling is performed as follows: the whole-body-circulation portion reads both pressure and flow values from the heart portion, while the heart portion reads pressure values in the arterial sinus and in the venous system from the circulation portion.

In one embodiment, the processor solves for the parameters based on a difference between measured and modeled values. The personalization may include running a forward model multiple times until certain objectives in the model outputs are met, such as minimization of differences between model-calculated values and measured values. Furthermore, simplified models may be used during this process to speed-up the iterations required for finalizing the personalization. For example, a reduced order model using fewer parameters (e.g., more lumping) is used to solve for the values of the parameters. Alternatively, the full-scale model (e.g., lumped, 3D, or lumped+3D) is used to solve for the values of the parameters based on the measurements from the specific patient.

Once a first personalization is performed, a sensitivity analysis and uncertainty quantification may be rerun to more accurately determine parameters for personalization for the current patient. Rather than performing the sensitivity analysis for the model in general, the sensitivity analysis is performed for the model as tuned or personalized to the specific patient.

Other models and/or solutions to personalize the models may be used. For example, the model and personalization disclosed in WO Publication 2015/153832 is performed. More simplistic modeling may be used, such as fitting a shape of the physics or mechanistic model to the spatial scan data or selecting between different templates based on the data representing the patient to find the template best matching the current patient.

The personalized model is used to calculate health data. A volume, volume flow, timing, relative timing, or other characteristic of the heart or function of the heart may be calculated from the personalized model. Any diagnostically useful parameter or indicator may be calculated. The computed cardiovascular metrics of interest may be used in patient stratification, disease estimation, and/or therapy planning. A typical use case is the non-invasive computation of left or right ventricular pressure-volume loops, but other diagnostically or therapeutically useful metrics may be computed. Machine learning based workflows may improve a physiological reduced-order model and/or may be used to derive a data-driven forward model with features extracted from a reduced-order physiological model. A full scale or greater scale than the reduced-order model is used in training the machine-learnt classifier.

The personalized model may be altered to simulate treatment. The effects of the treatment may be viewed and/or calculated. The resulting computational model is used to test different therapy configurations by computing acute predictors, which are used to determine if the patient will respond to treatment in a planning phase or guide the clinician towards the therapy target in intervention (e.g. placement of the left ventricle (LV) lead for cardiac resynchronization therapy (CRT)).

Estimates of future events or disease may be made from the model as a prognosis. Risk of adverse events may be provided by the model and/or based on parameters calculated from the model. The physician may use the personalized model in any of various ways.

The results from the personalized modeling may assist in treatment of the patient. Since the modeling may be time consuming or occur only upon need due to cost, the model is not updated or only updated by the physician at another visit. The other visit may be triggered by occurrence of an adverse event. In a more proactive approach, the personalized model is updated outside of the medical facility and/or at times other than during a patient visit. While the same information may not be available as used to create the model, the update may still better match the previously personalized model to the current state of the patient. The updated, personalized model may be used for regular, periodic, or on-going creation of health data to better monitor the patient. This monitoring may occur as the patient lives their life rather than only upon visits with a physician. The physician may be alerted to risk, occurrence of events, or other information derived from the model.

In act 24, the simulation processor updates the model. The model is updated based on data sensed from the patient. This sensed health data may be less than and/or different than used to personalize the model, but may be used to modify the model to better reflect a current state of the patient.

The updating occurs at least once, but may occur multiple times. For example, the updating occurs regularly or in an on-going manner. The update may be hourly, daily, weekly, or monthly. The update may be more frequent, such as every second or minute. The update may occur as data from a sensor is received, and the data may arrive at any rate.

Acts 26-34 represent one embodiment of on-going update of the personalized model. These acts are for one update, but may be repeated (e.g., repeating the sensing of act 26, modifying of act 32, and modeling of act 34) for on-going or real-time updating. Where the sensor provides data at least every few seconds, the repetitions may be in real-time for a live model computation. Less frequent updating may provide for a regular health verification or checking, such as for patients with less risk or sensors with lower rates.

Different, fewer, or additional acts than acts 26-34 may be provided for updating the model and modeling with the updated model. For example, acts 26, 32, and 34 are provided without acts 28 and 30. As another example, acts for receiving data or signals from the sensor, acts for activating the sensor, and/or acts for use of the personalized model may be provided for in the repetitions that are part of act 24.

In act 26, a sensor senses a patient. The sensor is an e-health sensor, such as a heart rate, pressure, step frequency, activity level, or temperature sensor. Other e-health sensors may include breathing cycle, oxygen saturation, or glucose level sensors. More than one sensor may be provided, such as two or more sensors in a same housing or different housings.

The sensor is wearable. For example, the sensor is part of a watch or strap on device for every-day use or use by the patient outside of a medical facility. The sensor may be part of a necklace, watch, strap, clothing, or pack for being worn on the wrist, neck, angle, arm, leg, back, waist, or other part of the body of the patient while outside the healthcare facility. In alternative embodiments, the sensor is not mobile, but is available to the patient at home or outside of a medical facility for regular sensing.

The sensor performs readings from the patient. The sensor acquires signals representing the patient at any time. Based on a timer or a trigger (e.g., user activation or occurrence of an event), regular, periodic, or on-going readings from the patient are performed. A signal or signals in analog or digital form are acquired at least every hour, but other rates may be provided. Irregular readings may occur.

When the readings occur faster than an update rate of the model, then readings may be acquired during and/or prior to completions of an update of the model. By storing these readings at the sensor, computer performing the update, or other location, the next update may use the readings. Non-lock or circular buffering provides for both acquisition of data from the sensor and use of the data where the rates of data acquisition is greater than the rate of updating. In alternative embodiments, updating occurs at a greater rate.

In act 28, the sensor transmits the readings to a server or other simulation processor. The transmission is wireless. Alternatively, the sensor is plugged into a device for wired transmission. The readings may be buffered, such as storing readings over a period and downloading the readings in batch mode upon connection or another trigger.

The transmission is direct or indirect. For example, the sensor transmits the readings to a phone, tablet or local computer using Wi-Fi, Bluetooth, or other transmit format. This intermediary device then transmits the readings over a computer network via TCP/IP to the simulation processor or data aggregator. In alternative embodiments, the phone, tablet, or local computer implement the simulation processor, so direct transmission is provided. In yet other embodiments, the simulation processor is implemented on the sensor, such as part of a processor of a computerized watch.

In act 30, the readings are received and stored. Each new reading or set of readings transmitted from the sensor are stored for use in updating. The storage is for any length of time. In one embodiment, the storage provides for maintaining readings where the personalized model is updated so that the readings are available for a future update. Alternatively, readings received during an update are discarded.

In one embodiment, the readings are stored in a circular buffer. The updating and modeling of acts 32 and 34 use the memory or part of the buffer. While the model is being updated in one slot, the readings are stored and/or queries to the model are read in another slot. Different threads of processing make calls to different slots of the circular buffer. For example, the updating occurs in a first slot using a first processing thread, and the modeling occurs in a second slot of the circular buffer using a second thread. The readings are stored in another location or in the slot used for updating. Once the update is complete, then the slots are switched as the older version of the model is then updated while the newer version operates as the current personalized model. In another embodiment, the heart model is updated live using multi-threading technology. First, a “listener” component is used to listen a network socket (e.g., interface for receiving readings over a computer network) for incoming sensor data. The received data is integrated into the model by modifying the respective parameters (e.g. heart rate, QRS duration, glucose, etc.). A computation is triggered in the background, in another thread, to calculate a new state of the organ model. A non-lock approach is used. The circular buffer with two slots is employed to store the organ model. Two heads are used, one for read, and one for write. Model queries are done using the read head. When re-computation is triggered, the model is updated and written using the write head. Read and write heads are then shifted accordingly and the model updated.

In act 32, the simulation processor updates the model. The update occurs once or multiple times. The update occurs in response to received readings, such as updating in response to each of the new readings. As another example, the update occurs after a threshold number or amount of readings are available. The update may be periodic, regular, or on-going. The most recent readings (e.g., readings received during and/or after the most recent update) are used to update the personalized model. Older readings may or may not be used.

To update, values of one or more parameters of the model are modified. The model is personalized to the patient. The received readings are used to further personalize or adjust the model to the current state of the patient. For example, the mechanistic or physics model of organ function is modified based on the signals from the sensing.

The update uses the same personalization to create the model. The same data is re-used, but with the added information from the readings from the sensor. Alternatively, the updating modifies based on the readings without re-performing the full creation. Different types of sensor data may be used to alter different parameters using a look-up table, direct mapping, or indirect solution. For example, the personalized model is optimized with an error function to provide a characteristic that matches the sensor reading. As another example, the sensor reading is mapped to a specific value using empirical data. The reading integration may be done statistically using machine learning.

Example parameters include time-varying flow rate for the heart, pressure variation for the heart, cardiovascular systemic impedance, and cardiovascular pulmonary impedance. Values for these parameters at one or multiple locations in the cardiac system are used in the model. Any number of parameters and correspondingly any number of values over time and/or space for each parameter may be used. Other example parameters used in the modeling may include systolic aortic pressure [mmHg], diastolic aortic pressure [mmHg], heart rate [bpm], ejection fraction [%], end-diastolic volume [ml], stroke volume [ml], left ventricular end-systolic pressure [mmHg], left ventricular end-systolic elastance [mmHg/ml], arterial compliance, volume (V), V_{0,*} [ml] (dead volume of the * chamber of the heart), V₁₀₀ [ml](left ventricular volume corresponding to a left ventricular pressure of 100 mmHg), proximal arterial resistance [g/(cm⁴·s)], distal arterial resistance [g/(cm⁴·s)], total arterial resistance [g/(cm⁴·s)], stroke work PV [J] (stroke work determined from computed PV loop), normalized stroke work PV [J/ml] (stroke work PV divided by stroke volume), stroke work PQt [J] (stroke work determined from computed ventricular pressure and aortic flow rate), normalized stroke work PQt [J/ml] (stroke work PQt divided by stroke volume), arterial elastance [mmHg/ml] (computed as end systolic pressure divided by stroke volume), and/or arterial ventricular coupling (arterial elastance divided by left ventricular end-systolic elastance). Additional, different, or fewer parameters may be used in the modeling and/or updating of the modeling. The parameters are of input variables used to model. Alternatively, one or more of the above listed variables are output metrics calculated from the model as personalized.

Various example modifications depend on the type of sensor. A heart rate reading is used to set the heart rate of the personalized model. A pressure reading may be used to set a load or boundary condition for the model. A step frequency or measure of activity may be used to set the heart rate, breathing rate, boundary conditions, or hemodynamic flow parameters. EKG information may be used to fit an electrophysiology parameter or parameters. The temperature may be used to indicate a condition, such as an infection. The condition may dictate boundary condition or other operation of the model. The temperature may be used in combination with a condition reflected in the model to indicate susceptibility or risk, triggering a warning. The readings may indicate a type of patient or diagnosis, resulting in a change in the model to reflect the type or diagnosis. Other mappings may be used.

In act 34, the simulation processor uses the updated, personalized model. The use corresponds to the updating, such as periodically modeling with a same period as the updating. Upon updating, the personalized model is used to calculate health data for the patient. For example, the health data is determined in response to each of the new readings from the sensor through updating and modeling. The use of the model may have a different period than for sensing or updating.

The organ or organ function is modeled with the mechanistic or other model as modified. The personalized model is modified to better reflect a current state of the patient. Once modified, the personalized model is used to calculate health data. The health data, such as one or more metrics, is the same or different health data for which the personalized model is originally created. A volume, volume flow, timing, relative timing, or other characteristic of the heart or function of the heart may be calculated from the personalized model. Any diagnostically useful parameter or indicator may be calculated. The personalized model may be altered to simulate treatment. The effects of the treatment may be viewed and/or calculated. Estimates of future events or disease may be made from the model as a prognosis. Risk of adverse events may be provided by the model and/or based on parameters calculated from the model. The physician may use the personalized model in any of various ways. The continuous monitoring of signals sensed from the patient may be used to infer models of organ growth and remodeling (e.g., reaction of the organ to treatment), which are then used to update the shape and dynamics of the virtual organ.

In act 36, the simulation processor outputs health data or other information derived from the personalized model. The output is provided with a same or different period as the updating and modeling. For example, the output is provided for each update. As another example, the output is provided only where a sufficient difference from previous health data or a triggered event occurs. The output from at least one iteration of the updating and modeling is provided.

The output is provided to the patient, physician, and/or electronic medical record for the patient. The output is transmitted via a computer network or directly to a display. The display provides a visual representation of the output.

The output is a risk of an adverse event for the organ based on at least one iteration of the periodic modeling. Diagnosis, prognosis, or event occurrence may be output. Calculated metrics used for diagnosis, prognosis, or risk may be provided, such as outputting a phasing relationship of electrical activation of the heart muscle, pressure, volume flow, PV loop, a stroke workload, arterial-ventricular coupling, isochrones volume foot, myocardial strain, and/or other information useful in accessing a condition of the patient. The output may be a warning of malfunction or a prediction of when malfunction of the organ may occur.

The health data (e.g., the metric or metrics) are indicated on a display. The metric may be a value, graph, vector field, or spatial distribution. The metric is displayed on a screen, such as displaying the PV loop or other values without comparison to measurements. Other displays of the health data may be provided, such as indicating a workflow or providing instructions based on the metric. In alternative embodiments, the metric is stored in the patient record and/or transmitted on a computer network.

The health data may be used to derive further information. Using machine training, deep learning, or based on clinical study, the health information may be used to suggest training plans, physical activities, drugs, or drug intake monitoring. The health data may be used to monitor for drug reaction. Drug prescriptions for the patient may be included in the personalization, such as through a pharmaco-kinetics model applied to update the state of the virtual organ. The effects personalized to the patient of the drug may be output.

In act 38, the simulation processor uses the personalized model in other ways than output to the patient or physician. Acts 40-46 are some examples, but other examples may be provided.

In act 40, a medical scanner is gated using the modeling. The same or different medical scanner used to acquire spatial data for the anatomy is used to scan the patient. For example, the patient makes another visit to the medical facility. The already existing, updated model is used to predict phasing of the heart. The medical imaging scanner scans at particular phases. This gating is guided, at least in part, by the personalized model for imaging the heart of the patient. Rather than controlling the scanning, the gating may be used to account for motion in reconstruction or imaging. The image or sequence of images adapt to motion of the heart as reflected by the model.

In act 42, the simulation processor generates an image of the organ. The image is generated from the model, such as using the model as a surface to be textured with scan data. The model may be rendered to a two-dimensional display, generating an image of the organ from the model. Where the model includes dynamic behavior, a sequence of images representing the organ over time is generated from the model.

In one embodiment, the images provide visualization of the virtual organ (i.e., the personalized model) on a mobile device. The image is generated in a cloud or by a local server (e.g., hospital server or patient home server) but communicated to a mobile or other device for display.

In another embodiment, an image is cinematically rendered from scan data. Since cinematically rendering relies on Monte Carlo or other statistical processing for tracing paths of photons to render a three-dimensional representation to a two-dimensional display, the rendering may initially take seconds. Since the heart varies through a whole cycle in around one second, the rendering does not keep pace with the heart cycle, at least initially. The model may be used to determine change in the rendered image over that time. The rendered image is altered to reflect the heart based on the model without having to repeat cinematic rendering at each phase. The motion of the organ for the alteration is based on the dynamic behavior of the organ represented in the personalized model.

In act 44, personalized model information is gathered from many patients. Where the simulation server or multiple servers perform the modeling for many patients, population-based information may be determined. The patients may be grouped by condition. Statistics about distribution of characteristics of the heart or other information may be obtained from the personalized models of the different patients. Statistical analysis of outcome, risk, and/or effective treatment may be gathered. Any population study may use the personalized models as those models are created or later. The spread of a disease reflected in the updated models (e.g., dynamic behavior reflecting an infection) may be determined. The continuously updated virtual organs may be used for clinical trials.

In act 46, the simulation processor or other processor provides a mitigation recommendation based on the information from the personalized model. The health data may indicate a condition, risk, diagnosis, or prognosis. Treatment options or recommendations for change in behavior are provided based on the indication.

In one embodiment, social media is used to communicate mitigation information. A “poke” system is implemented. A user “pokes” the virtual heart of another user, whom would receive a haptic, visual or sensory signal on his wearable device. The user pokes the virtual heart to indicate a concern and/or as a reward for indications of being healthy or getting healthier. Social networks or other consumer applications provide for remote monitoring of patients. Where the user identifies a health concern or adverse event not acted on by the physician or patient, the signal from the “poke” may be used as an alert to the hospital to trigger emergency assistance.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for personalized modeling with regular integration from a sensor system, the method comprising:
capturing spatial data of an organ of a patient with a medical scanner;
generating a model of dynamic behavior of the organ, the model personalized to the patient with the spatial data;
acquiring periodic readings from a wearable sensor worn by the patient;
in response to the periodic readings, periodically updating the model with a most recent reading;
periodically modeling the dynamic behavior of the organ with the model as updated; and
outputting a risk of an adverse event for the organ based on at least one iteration of the periodic modeling.

2. The method of claim 1 wherein capturing the spatial data comprises capturing ultrasound data of a heart of the patient with an ultrasound scanner, and wherein the model is of the heart.

3. The method of claim 1 wherein generating the model comprises generating an electro-mechanical model based on hemodynamics and electrophysiology.

4. The method of claim 1 wherein acquiring the periodic readings comprises acquiring heart rate, temperature, pressure, breathing cycle, oxygen saturation, glucose level, or step frequency.

5. The method of claim 1 wherein acquiring the periodic readings comprises acquiring with the wearable sensor being worn on a wrist, neck, or ankle of the patient outside of a medical facility.

6. The method of claim 1 wherein acquiring the periodic readings comprises acquiring a new one of the readings at least every hour, and wherein periodically updating and modeling comprise updating and modeling in response to each of the new ones of the readings.

7. The method of claim 1 wherein acquiring the periodic readings comprises acquiring a new one of the readings during and prior to completion of one of the periodic updates; and
further comprising storing the new one of the readings during the one of the periodic updates and using the new one for a subsequent one of the periodic updates.

8. The method of claim 1 wherein periodic updating and periodic modeling use a circular buffer with the updating occurring, for every other iteration, in a first slot of the circular buffer using a first thread and with the modeling occurring in a second slot of the circular buffer using a second thread, wherein the first and second slots are switched for other iterations.

9. The method of claim 1 further comprising wirelessly transmitting the readings from the wearable sensor to a server, and wherein the periodic updating and periodic modeling are performed by the server.

10. The method of claim 9 wherein wirelessly transmitting comprises wirelessly transmitting from the wearable sensor to a phone, and wirelessly transmitting from the phone to the server.

11. The method of claim 1 wherein acquiring the periodic readings comprises acquiring from the wearable sensor and at least another sensor worn by the patient.

12. The method of claim 1 wherein outputting the risk comprises outputting diagnosis, prognosis, or event occurrence.

13. The method of claim 1 wherein outputting the risk comprises warning of malfunction of the organ.

14. The method of claim 1 further comprising:
gating the medical scanner or another medical scanner for imaging the heart of the patient based on the modeling of the dynamic behavior.

15. The method of claim 1 further comprising:
generating an image of the organ on a mobile device, the image generated from the model.

16. The method of claim 1 further comprising:
calculating information from the modeling for the patient and modeling for other patients.

17. The method of claim 16 further comprising:
providing a mitigation recommendation based on the information.

18. A system for personalized modeling with regular integration of data, the system comprising:
a sensor for on-going sensing of a patient;
a memory configured to store values from the on-going sensing and a physics model of the patient; and
a processor configured to regularly fit the physics model to the patient based on the values received from the sensor since a previous update, to determine a state of the patient from the updated model, and to generate an output for the patient based on the state.

19. The system of claim 18 wherein the memory comprises a circular lock-free buffer with at least two slots cycling between storing the values while the processor fits the physics model and determines the state.

20. A method for personalized modeling with regular integration from a sensor system, the method comprising:
sensing signals from a patient outside a medical facility with an e-health sensor;
modifying a parameter personalizing a mechanistic model of organ function of the patient based on signals from the sensing;
modeling the organ function with the mechanistic model as modified;
repeating the sensing, modifying, and modeling in real-time; and
transmitting health data for the patient from at least one iteration of the modeling.
